(19) United States
(12) Patent Application Publication
(10) Pub. No.: US 2006/0046778 A1
(43) Pub. Date: Mar. 2, 2006

(54) System for listening to playback of music files by a portable audio device while in a vehicle

(76) Inventor: Ryan M. Hembree, Mission, KS (US)

Correspondence Address: Gerhard Shipley, 4901 Main Street, Suite 220, Kansas City, MO, 64112, US

(21) Appl. No.: 10/929,508

(22) Filed: Aug. 30, 2004

(51) Int. Cl. H04B 1/38

(52) U.S. Cl. 455/557

(57) ABSTRACT

A system for removably connecting and interfacing an electronic portable audio device with an otherwise substantially conventional vehicle audio system to facilitate listening to playback of electronic music files stored on the portable audio device. A docking connector for receiving the portable audio device is physically and operatively integrated into a shared housing with the vehicle audio system, and a single set of controls is provided for controlling operation of both the portable audio device and all conventional components of the vehicle audio system. A removable interface module allows for adapting the system for use with differently designed portable audio devices.

### BACKGROUND OF THE INVENTION

1. Field of the Invention

The present invention relates broadly to technologies for listening to playback of digital or other electronic music files by an electronic portable audio device while in a vehicle. More specifically, the present invention concerns a system for removably connecting and interfacing an electronic portable audio device with an otherwise substantially conventional vehicular audio system in order to facilitate listening to playback of digital or other electronic music files stored on the portable audio device.

2. Description of the Prior Art

Electronic portable audio devices, such as the iPod family of devices by Apple Computer, Inc., for storing and playing digital or other electronic music files are becoming increasingly popular. It is generally considered desirable to minimize the size and weight of these portable audio devices, and therefore few, if any, include integrated loudspeakers. Instead, the portable audio devices must be connected to headphones or other external devices in order to listen to playback of the electronic music files. These external devices include, for example, docking stations for connecting the portable audio devices directly to loudspeakers or to personal computers having loudspeakers.

It is often desirable, however, to listen to playback of the electronic music files while in a car, truck, boat, airplane, or other vehicle. To that end, a variety of prior art devices have been developed to facilitate such listening. A first class of such devices uses an existing conventional cassette player component of an existing conventional in-dash cassette player and radio receiver unit. More specifically, an interface device is provided consisting of a length of electrical wire having a connector at one end for connecting to a headphone jack of the portable audio device, and a cassette-like connector at an opposite end for insertion into the cassette player. Playback is communicated via the electrical wire to the cassette player and radio receiver unit which allows for listening via the vehicle's existing conventional loudpeakers. The portable audio device must be physically supported in such a manner as to allow for access to and use of the device's existing controls to control selection and playback of the electronic music files. A variety of mechanical support mechanisms are available for this purpose, some of which utilize the vehicle's existing conventional cup holder. Unfortunately, this first class of prior art devices suffers from a number of problems and disadvantages, including, for example, that (1) they require an in-dash cassette player component, which, with the advent of compact discs, are becoming increasingly uncommon, and (2) the openly-supported portable audio device and the electrical wire extending between the portable audio device and the cassette player component may be unsightly and aesthetically unappealing, particularly in more expensive or sophisticated vehicles.

A second class of such devices transmits playback of the electronic music files via an FM signal that is received by the vehicle's existing conventional in-dash radio receiver unit, which similarly allows for listening via the vehicle's existing conventional loudspeakers. Typically, a mechanical support and interface component is provided for receiving, retaining, and interfacing with the portable audio device and transmitting the FM signal. The portable audio device is retained in such a manner as to allow for access to and use of the device's existing controls to control selection and playback of the electronic music files. Where such a mechanical support is not provided, the portable audio device must be otherwise appropriately physically supported in an accessible condition. Unfortunately, this second class of prior art devices suffers from the same problems and limitations of the first class, including the unsightly and aesthetically unappealing mechanical support needed to support the portable audio device. Additionally, reception of the transmitted FM signal by the existing radio receiver can be poor, particularly in areas where the frequency of the transmitted FM signal substantially coincides with a broadcast frequency being used by an actual radio station.

A third class of such devices provides an interface connector located in the vehicle's glove box area, and a control component located on the vehicle's steering wheel. The interface connector is connected to the vehicle's existing conventional audio system, and the portable audio device is removably connected to the interface connector, thereby interfacing the portable audio device with the audio system so that playback can be heard through the existing conventional loudspeakers. Both the portable audio device and the interface connector are hidden within the glove box, thereby minimizing aesthetic impact, and, because the portable audio device's existing controls cannot be accessed, the steering-wheel mounted controls allow for controlling selection and playback.

Unfortunately, this third class of prior art devices suffers from its own particular problems and limitations. For example, connecting the portable audio device to the connector located in the vehicle's glove box can be inconvenient for the driver of the vehicle. The driver, upon entering the vehicle, must reach across the center console, gear shift, and emergency brake; open the glove box; stretch even farther to reach the interface connector laying in the glove box; connect the portable audio device; and close the glove box. When the driver reaches his or her destination, this process must be repeated in reverse order to disconnect the portable audio device for removal. The strenuous physical contortions needed to accomplish the connect disconnect process make it likely that the connection will not be used, particularly for relatively short trips, or that the portable audio device will be left connected, particularly for relatively short stops. In both cases, the user is unable to enjoy full use of the portable audio device.

Furthermore, this third class of prior art devices requires a separate and distinct control component for controlling selection and playback of the electronic music files by the portable audio device. Being located on the steering wheel, the control component is, as a practical matter, only accessible to the driver of the vehicle. It will be appreciated, however, that the control component of a conventional vehicle audio system is traditionally located between the driver and passenger areas where it can be easily and conveniently reached by both the driver and the passenger. Thus, this third class of prior art devices is substantially less flexible and user-friendly than is desirable with regard to use and control.

Due to the above-identified and other problems and disadvantages in the prior art, a need exists for an improved system for listening to playback of electronic music files by an electronic portable audio device while in a vehicle.

### SUMMARY OF THE INVENTION

The present invention overcomes the above-described and other problems and disadvantages in the prior art by providing an improved system for facilitating selective connection of an electronic portable audio device to an otherwise substantially conventional in-dash vehicle audio system via a docking component integrated into a shared housing.

In a preferred first embodiment, the system comprises a compact disc (CD) player component; an AM/FM radio receiver component; the docking component; a control component; and a display. The CD player, AM/FM receiver, and display are of substantially conventional technology commonly available and found in existing vehicle audio systems. The docking component receives and retains the portable audio device and operatively interfaces the portable audio device with the vehicle audio system. This interface functionality includes, for example, communicating music, or, more specifically, electronic data corresponding to music, from the portable audio device to the vehicle audio system, and communicating control signals from the control component to the portable audio device. The dock component includes a receiving bay and an interface connector. The receiving bay slidably receives and removably retains the portable audio device. The interface connector connects to a dock connector on the portable audio device and facilitates receiving and transmitting electronic data and control signals to and from the docking component and the interfaced portable audio device.

The control component allows for controlling operation of the CD player, the AM/FM receiver, and the interfaced portable audio device. The control component preferably includes a tuning/selector dial; a plurality of numbered station preset buttons; a plurality of selection control buttons; and an eject button. These elements of the control component are otherwise substantially similar or identical in appearance and functionality to conventional control elements commonly associated with CD players and AM/FM receivers. When the portable audio device is not interfaced with the vehicle audio system, the control elements are, in fact, used to control the CD player and AM/FM receiver in a conventional manner.

In a preferred second embodiment, the system includes an interface module for adapting the system for use with differently designed portable audio devices. More specifically, the interface module receives and retains the portable audio device, and is, in turn, received and retained within the receiving bay of the docking component. The interface module includes a receiving sleeve; an interface coupler; a spring-loaded ejection mechanism; a faceplate having a spring-loaded door; and a securement mechanism. The receiving sleeve closely receives the portable audio device. The interface coupler is located at one end of the receiving sleeve and is interposed between and interfaces the dock connector of the portable audio device with the interface connector of the docking component.

The spring-loaded ejection mechanism contacts a bottom surface of the fully-inserted portable audio device and functions, when activated, to mechanically push the portable audio device forward so that the top portion of the device protrudes sufficiently from the receiving bay to be easily grasped for removal and, in doing so, automatically disconnects the dock connector from the interface coupler. The faceplate presents an opening through which the portable audio device is inserted into the receiving sleeve. This opening preferably closely coincides with the shape of the portable audio device, and, to that end, a variety of interchangeable faceplates may be made available. The spring-loaded door is hingedly coupled with the faceplate over the opening to prevent contaminants from entering the receiving sleeve when the portable audio device is not present. The securement mechanism removably or permanently secures the interface module within the receiving bay.

In a preferred third embodiment, the system supplements rather than replaces an existing conventional vehicle audio system. The system may be installed in an unoccupied slot in the vehicle's dash, preferably immediately below the existing vehicle audio system so as to be equally accessible. The system includes the docking component, but does not include the CD player or AM/FM receiver of the first and second embodiments as those components are already present in the existing vehicle audio system.

Thus, it will be appreciated that the system of the present invention provides a number of substantial advantages over the prior art, including, for example, substantially eliminating unsightly and aesthetically unappealing wiring and support mechanisms by integrating the docking component for the portable audio device more fully into the vehicle audio system or dash/console of the vehicle. Relatedly, the system positions the interfaced portable audio device and the controls therefor in a substantially centralized location where they can be conveniently accessed and controlled by both driver and passenger. This is in clear contrast to the prior art which locates the portable audio device in the vehicle's glove box where it cannot be conveniently accessed by the driver, and locates the controls on the vehicle's steering wheel where they cannot be conveniently accessed by the passenger. Additionally, the system utilizes the conventional controls of the audio system to select and control playback of the electronic music files stored on the portable audio device. Also, the interface module of the second embodiment and the docking-component-only system of the third embodiment allow for easily and conveniently adapting the present invention for use with any of a variety of differently designed portable audio devices.

These and other important features of the present invention are more fully described in the section titled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is a front elevation view of an exemplary electronic portable audio device for use with the present invention;

FIG. 2 is a front elevation view of a preferred first embodiment of the system of the present invention;

FIG. 3 is a sectional plan view of an interface module component of a preferred second embodiment of the system of the present invention, wherein the remainder of the second embodiment of the system is substantially similar or identical to the system shown in FIG. 2;

FIG. 4 is an isometric view of the interface module component of FIG. 3;

FIG. 5 is a left elevation section view of the interface module component of FIG. 3;

FIG. 6 is a front elevation view of a possible first faceplate for use with the interface module component of FIG. 3;

FIG. 7 is a front elevation view of a possible second faceplate for use with the interface module component of FIG. 3;

FIG. 8 is a front elevation view of a possible third faceplate for use with the interface module component of FIG. 3; and

FIG. 9 is front elevation view of a preferred third embodiment of the system of the present invention.

### DETAILED DESCRIPTION OF THE PREFERRED EMBODIMENTS

With reference to the figures, a system is herein described, shown, and otherwise disclosed in accordance with the preferred embodiments of the present invention. In a preferred first embodiment, the system 10 facilitates selective connection of an electronic portable audio device 12 to an otherwise substantially conventional in-dash vehicle audio system 14 via a docking component 34 integrated into a shared housing 16.

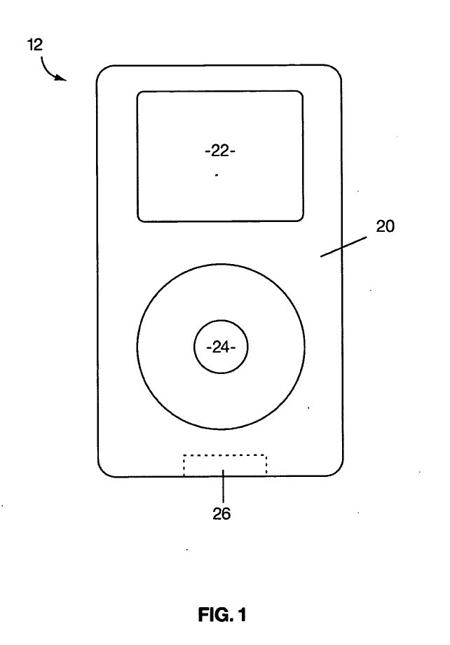

The portable audio device 12 may be any of a number of widely available, substantially conventional electronic portable audio devices, such as, for example, the iPod 40GB, iPod 20GB, or iPod mini by Apple Computer, Inc; the Digital Jukebox DJ15 or DJ20 by Dell Inc.; or the Network Walkman™ NW-HD1 by Sony Corporation. Referring to FIG. 1, an exemplary portable audio device 12 is illustrated having a substantially rectangular body 20; a display 22 and controls 24 arranged upon a front surface of the body 20; and a dock connector 26 located on a bottom surface of the body 20. It will be understood and appreciated that other shapes, control arrangements, and dock connector locations are possible, some or all of which, it is contemplated, would be accommodated in the system 10 of the present invention either through minor design changes or by changeable or replaceable components (such as, e.g., a changeable faceplate 68, discussed below).

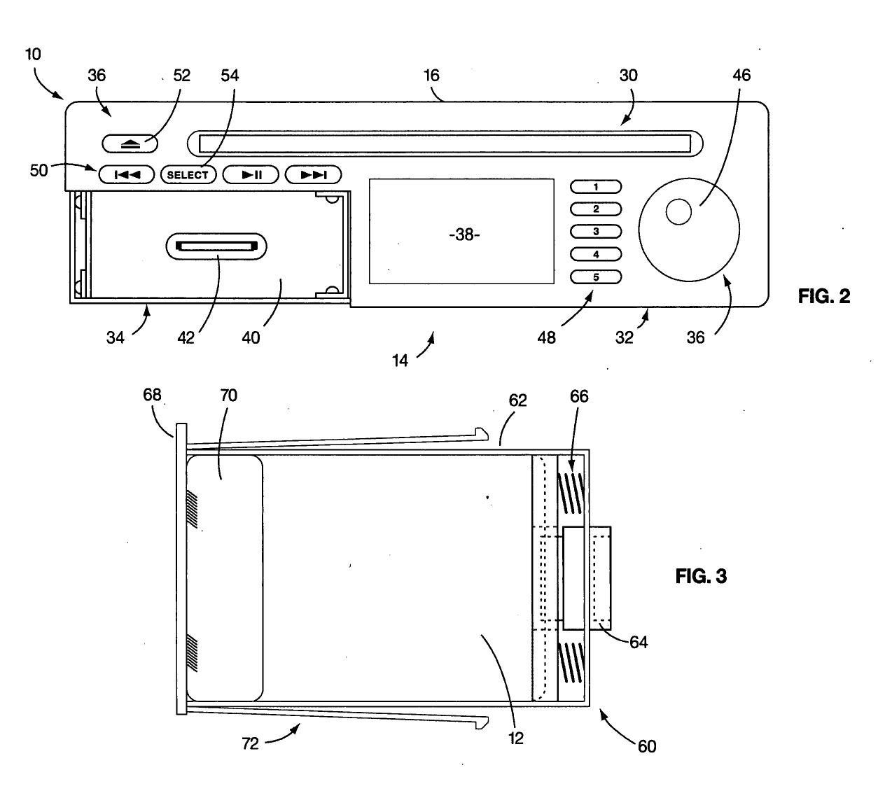

Referring also to FIG. 2, a preferred first embodiment of the system 10 is shown broadly comprising a compact disc (CD) player component 30; an AM/FM radio receiver component 32; the docking component 34; a control component 36; a display 38; and the housing 16 which is adapted to physically contain or otherwise mechanically support all or substantially all of the aforementioned components. The CD player 30, AM/FM receiver 32, and display 38 are of substantially conventional technology commonly available and found in existing vehicle audio systems.

The docking component 34 is adapted and operable to receive and retain the portable audio device 12 and to operatively connect or interface the portable audio device 12 with the vehicle audio system 14. The docking component 34 includes appropriate electronic and mechanical hardware, firmware, or software or any combination thereof necessary to accomplish this connection/interface functionality, the design and construction details of which are considered to be within the abilities of one with ordinary skill in the relevant art. The connection/interface functionality includes, for example, communicating music or digital data corresponding to music from the portable audio device 12 to the vehicle audio system 14, and communicating control signals from the control component 36 to the portable audio device 12.

The dock component 34 includes a receiving bay 40 and an interface connector 42. The receiving bay 40 slidably receives and removably retains the portable audio device 12. The interface connector 42 connects to the dock connector 26 of the portable audio device 12 and facilitates receiving and transmitting electronic data and control signals to and from the docking component 34 and the interfaced portable audio device 12. The interface connector 42 also preferably allows for charging the portable audio device's rechargeable battery when the vehicle audio system 14 is powered or the vehicle's engine is running.

When the portable audio device 12 is fully inserted into the docking component 34, it is preferred that approximately between 0.25 inches and 0.50 inches of the top portion of the portable audio device 12 will protrude outward from the receiving bay 40 to facilitate subsequent removal of the portable audio device 12 therefrom.

The control component 36 allows for controlling operation of the CD player 30, the AM/FM receiver 32, and the interfaced, portable audio device 12. The control component 36 preferably includes a tuning/selector dial 46; a plurality of numbered station preset buttons 48; a plurality of selection control buttons 50; and an eject button 52. These elements of the control component 36 are otherwise substantially similar or identical in appearance and functionality to conventional control elements commonly associated with CD players and AM/FM receivers. When the portable audio device 12 is not interfaced with the vehicle audio system 14, the control elements are, in fact, used to control the CD player 30 and AM/FM receiver 32 in a conventional manner.

When the portable audio device is interfaced, however, the tuning/selector dial 46 preferably functions substantially similar or identical to the “click wheel” or “touch wheel” control currently used on the iPod and similar devices. More specifically, rotating the tuning/selector dial 46 allows for scrolling through a playlist menu presented on the display 38, with each file or menu option being highlighted in turn; and pushing the tuning/selector dial 46 causes the highlighted file or menu option to be selected.

Additionally or alternatively, rather than using the tuning/selector dial 46 as a control in the aforementioned manner, the four selection control buttons 50, normally used to control the CD player 30, may, when the portable audio device 12 is interfaced, be used to scroll through and select files or menu options displayed on the display 38. The selection control buttons 50 may include a play/pause button, a forward button, a reverse button, and a select or menu button 54. When the portable audio device 12 is not interfaced, the select or menu button 54 may allow for selecting one of the CD player 30, AM radio subcomponent, or FM radio subcomponent to control.

Additionally or alternatively, the system 10 may be designed such that the control component 36 is not necessarily dedicated to controlling the portable audio device 12 when it is interfaced. Instead, the select or menu button 54 may allow for selecting or deselecting the portable audio device 12 from among the other components 30,32 of the vehicle audio system 14 such that those other components 30,32 can, if selected, be controlled in a substantially conventional manner regardless of whether the portable audio device 12 is interfaced. In this implementation, the control component 36 may default to the portable audio device 12 when it is initially interfaced regardless of whether the CD player 30 or AM/FM receiver 32 is selected at the time of interfacing, or, alternatively, the selected CD player 30 or AM/FM receiver 32 may remain selected until purposefully deselected by the user in favor of the portable audio device 12.

When the portable audio device 12 is interfaced (and selected for control), depressing the eject button 52 causes the docking component 34 to operatively disconnect from the portable audio device 12 so that the device 12 can be grasped and safely pulled from the receiving bay 40. Preferably, as discussed below, depressing the eject button 52 also causes the interface connector 42 to physically disconnect from the portable audio device 12 as well, thereby facilitating even easier removal.

When the portable audio device 12 is interfaced (and selected for control), the display 38 presents or communicates the same information (e.g., playlists, music files, functions, menus) that would otherwise be communicated by the display 22 of the uninterfaced device. 12.

As mentioned, the housing 16 is adapted to physically contain or otherwise mechanically support all or substantially all of the other aforementioned components of the system 10. This is in direct contrast to the prior art which does not integrate or otherwise physically incorporate a docking component into the same housing as an otherwise conventional CD player, AM/FM receiver, and other components.

If a headphone jack of the portable audio device is not accessible when the device 12 is interfaced (i.e., is not on a top surface of the device 12), or if the device 12 has no such headphone jack, then a headphone jack (not shown) may be included in the system 10 to allow for headphone use.

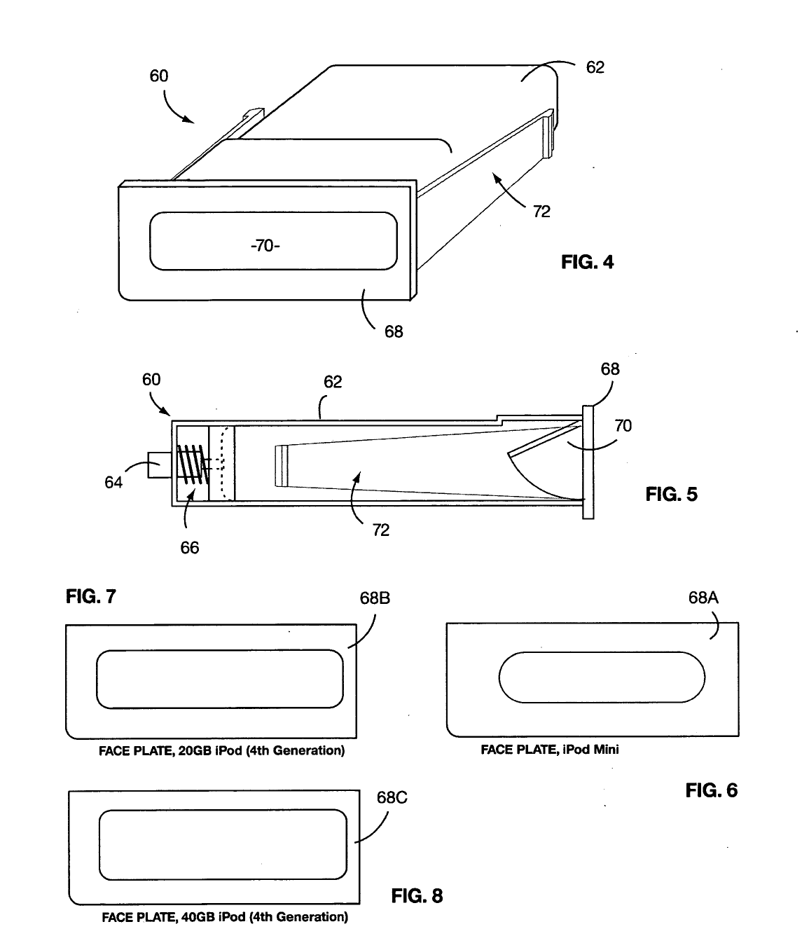

Referring to FIGS. 3-5, an interface module 60 is shown for use with a preferred second embodiment of the system which is substantially similar or identical to the above-described first embodiment but for the following differences. It will be understood and appreciated that portable audio devices can vary considerably with regard to such design factors as size, shape, capabilities, and interface requirements. For example, the iPod mini, iPod 20GB, and iPod 40GB, vary considerably in size: between 3.6 inches and 4.1 inches in length; between 2.0 inches and 2.4 inches in width; and between 0.5 inches and 0.73 inches in depth. Because the vehicle audio system 14 portion of the system 10 can be very expensive, particularly if high-performance or exceptionally high-quality components are used, it is desirable to be able to adapt the docking component 34 for use with differently designed portable audio devices 12, rather than requiring the purchase of an entirely new system. Similarly, from a manufacturing perspective, it may be more efficient and cost-effective to be able to mass-produce identical docking components 34 and vehicle audio systems 14, and thereafter adapt the docking component 34 for use with a particular portable audio device. The interface module 60 allows for this flexibility.

The interface module 60 is adapted and operable to be received and retained within the receiving bay 40 of the docking component 34, and to, in turn, receive and retain the portable audio device 12. The interface module 60 includes a receiving sleeve 62; an interface coupler 64; a spring-loaded ejection mechanism 66; a faceplate 68 having a spring-loaded door 70; and a securement mechanism 72. The receiving sleeve 62 closely receives the portable audio device 12. The interface coupler 64 is located at one end of the receiving sleeve 62 and is interposed between and connects/interfaces the dock connector 26 of the portable audio device 12 with the interface connector 42 of the docking component 34. It will be understood and appreciated that the interface coupler 64 may provide a direct, one-to-one connection, or, alternatively, may play a more active role in adapting the particular portable audio device for connection to the interface connector 42 by, e.g., eliminating, combining, or adding pins or other connections or by pre-processing or translating data, control, or other signals present on the pins or other connections.

The spring-loaded ejection mechanism 66 contacts the bottom surface of the fully-inserted portable audio device 12 and functions, when activated, to mechanically push the portable audio device 12 forward so that the top portion of the device 12 protrudes even further from the receiving bay 40 and is more easily grasped for removal, and, in doing so, automatically disconnects the dock connector 26 from the interface coupler 64. As necessary, a hole or opening may be provided in the ejection mechanism 66 to allow the docking connector 26 to pass through the ejection mechanism 26 and connect with the interface coupler 64. The ejection mechanism 66 is activated by depressing the eject button 52. Additionally or alternatively, the ejection mechanism 66 may be mechanically actuated by pushing slightly against the top surface of the fully-inserted portable audio device 12 to cause a release of the springs of the ejection mechanism 66. Such mechanical actuation can be achieved with, for example, an otherwise conventional spring-loaded push-to-release type mechanism.

The faceplate 68 is located at an opposite end of the receiving sleeve 62 from the interface coupler 64, and presents an opening through which the portable audio device 12 is inserted into the receiving sleeve 62. This opening preferably closely coincides with the shape of the portable audio device 12, and, to that end, as shown in FIGS. 6,7,8, a variety of interchangeable faceplates 68a,68b,68c may be used or made available. The spring-loaded door 70 is hingedly coupled with the faceplate 68 over the opening to prevent dust, debris, moisture, and other undesirable substances or contaminants from entering the receiving sleeve 62 when the portable audio device 12 is not present.

The securement mechanism 72 secures the interface module 60 within the receiving bay 40. Where it is desirable to allow end-users to swap interface modules to accommodate differently designed portable audio devices, the securement mechanism 72 may be designed so as to be easily releaseable or disengageable to facilitate such swapping. Where it is desirable only to mass-produce otherwise substantially identical systems and allow for subsequently permanently adapting the docking component 34 for use with a particular portable audio device, the securement mechanism 72 may be designed without a release or disengagement mechanism.

In exemplary use and operation, a particular implementation of the preferred second embodiment may function as follows. It should be understood and appreciated that the present example is non-limiting in that it does not account for all possible implementations or design variations, some of which are expressly discussed herein and others of which may be obvious given the present disclosure. Assuming the interface module 60 has already been inserted into the receiving bay 34, a user first inserts the portable audio device 12 through the opening of the faceplate 68, past the spring-loaded door 70, and into the receiving sleeve 62 until the docking connector 26 fully connects with the interface coupler 64. The act of inserting the portable audio device 12 in this manner automatically sets the spring-loaded ejection mechanism 66. When the portable audio device 12 is fully inserted and interfaced in this manner, the top portion of the device 12 will protrude slightly past the faceplate 68 to facilitate subsequent grasping and removal of the device 12. The control component 36 switches from controlling the CD player 30 and the AM/FM receiver 32 to controlling the portable audio device 12. Thereafter, the portable audio device 12 may be controlled using the tuning/selector dial 36 or the control buttons 50 in the manners discussed above.

When it is desired to remove the portable audio device 12, such as, for example, when exiting the vehicle, the user depresses the eject button 52 causing the springs of the spring-loaded ejection mechanism 66 to release, thereby physically pushing the portable audio device 12 further out of the receiving sleeve 62, and, in so doing, disconnecting the docking connector 26 from the interface coupler 64, so that the device 12 may be easily grasped and pulled completely from the receiving sleeve 62. Once the portable audio device has been removed, the spring-loaded door 70 automatically closes to protect the receiving bay 62 from contamination by undesirable substances.

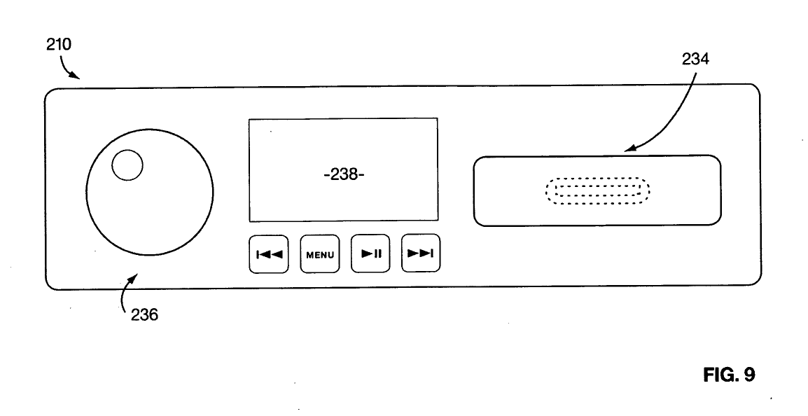

Referring to FIG. 9 a preferred third embodiment of the system 210 of the present invention is shown which is substantially similar or identical to the preferred first or second embodiments but for the following differences. The preferred third embodiment supplements rather than replaces an existing, conventional vehicle audio system. The system 210 may be installed in an unoccupied slot in the vehicle's dash, preferably immediately below the existing vehicle audio system so as to be equally accessible. The system 210 includes the docking component 234, but does not include the CD player or AM/FM receiver of the first and second embodiments as those components are already present in the existing vehicle audio system. The system 210 is hardwired into (using, e.g., male or female electrical connectors) or otherwise connected to the existing vehicle audio system so as to make use of the existing system's loudspeakers. As desired, the existing vehicle audio system control component and display can be used to control operation of the portable audio device 12 in the manner described above, or a separate but substantially similar or identical control component 236 and display 238 can be provided with the system 210.

From the preceding description it will be appreciated that the system of the present invention provides a number of substantial advantages over the prior art, including, for example, substantially eliminating unsightly and aesthetically unappealing wiring and support mechanisms by integrating the docking component for the portable audio device more fully into the vehicle audio system or dash/console of the vehicle. Relatedly, the system positions the interfaced portable audio device and the controls therefor in a substantially centralized location where they can be conveniently accessed and controlled by both driver and passenger. This is in clear contrast to the prior art which locates the portable audio device in the vehicle's glove box where it cannot be conveniently accessed by the driver, and locates the controls on the vehicle's steering wheel where they cannot be conveniently accessed by the passenger. Additionally, the system utilizes the conventional controls of the audio system to select and control playback of the electronic music files stored on the portable audio device. Also, the interface module of the second embodiment and the docking-component-only system of the third embodiment allow for easily and conveniently adapting the present invention for use with any of a variety of differently designed portable audio devices.

Although the invention has been described with reference to the preferred embodiments illustrated in the drawings, it is noted that equivalents may be employed and substitutions made herein without departing from the scope of the invention as recited in the claims. For example, features or portions of the interface module of the preferred second embodiment, such as the spring-loaded ejection mechanism, may be incorporated into the systems of the first or third embodiments without incorporating the interface module in its entirety.

We claim:

1. A system for interfacing an electronic portable audio device with an otherwise substantially conventional vehicle audio system, the system comprising:
a housing;
a docking component physically integrated into the housing and adapted to removably receive the portable audio device and to operatively interface the portable audio device with the vehicle audio system; and
a control component for controlling operation of both the portable audio device and one or more conventional components of the vehicle audio system.

2. The system as set forth in claim 1, wherein the docking component includes a receiving bay for receiving the portable audio device such that, when the portable audio device is so received, an existing set of controls on the portable audio device are not accessible for use.

3. The system as set forth in claim 1, wherein the conventional components of the vehicle audio system include a compact disc player component and an AM/FM radio receiver component.

4. The system as set forth in claim 1, wherein the docking component and the conventional components of the vehicle audio system are physically integrated into the housing.

5. The system as set forth in claim 1, further including a display, wherein the display is adapted to display control choices and otherwise facilitate controlling operation of the portable audio device and the conventional components of the vehicle audio system.

6. The system as set forth in claim 1, wherein the docking component includes a spring-loaded ejection mechanism for ejecting the portable audio device from the docking component.

7. The system as set forth in claim 1, further including an interface module received within the docking component and which, in turn, removably receives the portable audio device.

8. The system as set forth in claim 7, wherein the interface module includes a spring-loaded ejection mechanism for ejecting the portable audio device from the interface module.

9. The system as set forth in claim 7, wherein the interface module is removably received within the docking component.

10. The system as set forth in claim 7, wherein the interface module includes a replaceable faceplate for adapting the interface module for use with any of a variety of differently designed portable audio devices.

11. A system for interfacing an electronic portable audio device with an otherwise substantially conventional vehicle audio system, the system comprising:
a docking component physically integrated with the vehicle audio system and adapted to operatively interface the portable audio device with the vehicle audio system;
an interface module received within the docking component and which, in turn, removably receives the portable audio device, wherein the interface module includes a spring-loaded ejection mechanism for ejecting the received portable audio device from the interface module; and
a control component for controlling operation of both the portable audio device and one or more conventional components of the vehicle audio system.

12. The system as set forth in claim 11, wherein the docking component includes a receiving bay for receiving the interface module such that, when the interface module is so received, and the portable audio device is received within the interface module, an existing set of controls on the portable audio device are not accessible for use.

13. The system as set forth in claim 11, wherein the conventional components of the vehicle audio system include a compact disc player component and an AM/FM radio receiver component.

14. The system as set forth in claim 11, further including a housing, wherein the docking component and the conventional components of the vehicle audio system are physically integrated into the single housing.

15. The system as set forth in claim 11, further including a display, wherein the display is adapted to display control choices and otherwise facilitate controlling operation of the portable audio device and the conventional components of the vehicle audio system.

16. The system as set forth in claim 11, wherein the interface module is removably received within the docking component.

17. The system as set forth in claim 11, wherein the interface module includes a replaceable faceplate for adapting the interface module for use with any of a variety of differently designed portable audio devices.

18. A system for interfacing an electronic portable audio device with an otherwise substantially conventional vehicle audio system, the system comprising:
a docking component, including a receiving bay, adapted to operatively interface the portable audio device with the vehicle audio system;
an interface module removably received within the receiving bay of the docking component and which, in turn, removably receives the portable audio device, wherein the interface module includes a spring-loaded ejection mechanism for ejecting the received portable audio device from the interface module;
a control component for controlling operation of the portable audio device and one or more conventional components of the vehicle audio system;
a display, wherein the display is adapted to display control choices and otherwise facilitate controlling operation of the portable audio device and the conventional components of the vehicle audio system; and
a housing, wherein the docking component, the control component, the conventional components of the vehicle audio system, and the display are all physically integrated into the housing.

19. The system as set forth in claim 18, wherein the conventional components of the vehicle audio system include a compact disc player component and an AM/FM radio receiver component.

20. The system as set forth in claim 18, wherein the interface module includes a replaceable faceplate for adapting the interface module for use with any of a variety of differently designed portable audio devices.
